(19) United States
(12) Patent Application Publication
(10) Pub. No.: US 2026/0369091 A1
(43) Pub. Date: Nov. 19, 2026

(54) SYSTEMS AND METHODS FOR GENERATING DYNAMIC SIGNATURE PLACEHOLDERS USING MACHINE LEARNING

(71) Applicant: OPEN TEXT INC., Menlo Park, CA (US)

(72) Inventor: Mudit Parnami, Bengaluru (IN)

(21) Appl. No.: 19/212,508

(22) Filed: May 19, 2025

(51) Int. Cl. G06V 30/14; G06V 30/142; G06V 30/146

(52) U.S. Cl. CPC G06V 30/1444; G06V 30/1423; G06V 30/147

(57) ABSTRACT

A document is received from a user device and an image of the document is generated and processed by providing the image as input to an optical character recognition (OCR) facility. The OCR facility is operable to recognize characters in the image and output a text string containing the recognized characters from the image and bounding box coordinates for the recognized characters. The text string is communicated to a large language model (LLM) service, which takes the text string as input and returns a response containing words of interest identified from the text string. Utilizing the bounding box coordinates for the recognized characters and based on the words of interest in the document, signature placeholders and corresponding coordinates can be determined. The signature placeholders can then be positioned at the signature placeholder coordinates over the document displayed on the user device.

### TECHNICAL FIELD

This disclosure relates generally to document processing and electronic signatures. More particularly, this disclosure relates to systems, methods, and computer program products for content-based generation of dynamic signature placeholders leveraging machine learning.

### BACKGROUND OF THE RELATED ART

Today, to generate an electronic signature placeholder in a document, a user reviews the document on a user device, finds an appropriate spot in the document, and manually inserts an input data field specified for someone's electronic signature. This is a manual, often tedious and time-consuming, process.

This manual approach to generating electronic signature placeholders does not scale well as the number of pages in a document increases and/or as the number of signers increases. Consequently, there is a need for a better, smarter, more efficient way of inserting electronic signature placeholders in documents. The invention disclosed herein can address this need and more.

### SUMMARY OF THE DISCLOSURE

A goal of this disclosure is to provide an artificial intelligence (AI)-assisted solution that automatically intelligently inserts dynamic electronic signature placeholders in documents wherever appropriate, with minimal user involvement, if any. In embodiments disclosed herein, this goal is accomplished by leveraging machine learning (ML), particularly a large language model (LLM), in an innovative way.

In some embodiments, a method for content-based generation of dynamic signature placeholders can include receiving, through a document upload service, a document from a user device; generating, utilizing a document conversion service, an image of the document; and processing, utilizing a text-to-coordinates mapping service, the image of the document. More specifically, the image of the document is provided as input to an optical character recognition (OCR) facility. The OCR facility is operable to recognize characters in the image and output a text string containing the recognized characters from the image and bounding box coordinates for the recognized characters. The text string is communicated to an LLM service, which takes the text string as input and returns a response containing words of interest identified from the text string. In some embodiments, the method further comprises determining, utilizing a mapping service and the bounding box coordinates for the recognized characters: signature placeholders based on the words of interest in the document; and signature placeholder coordinates in the document for the signature placeholders.

In some embodiments, the signature placeholders and their corresponding signature placeholder coordinates can be stored in a metadata database. In some embodiments, the signature placeholders with the signature placeholder coordinates are returned to the document upload service which, in turn, positions the signature placeholders at the signature placeholder coordinates over the document displayed on the user device.

In some embodiments, the signature placeholders can be determined by identifying signing parties from the words of interest and, for each respective signing party, determining a signature location near the respective signing party for placing a corresponding signature placeholder. In some embodiments, each respective signing party can be identified from the words of interest by determining a first name and a second name of the respective signing party and concatenating the first name and the second name to identify the respective signing party.

In some embodiments, a suitable signature location can be determined by positioning a grid overlaying the image of the document and identifying the respective signing party and the signature location using the grid. In some embodiments, the grid can consist of a first number of cells each having a first cell size. Responsive to not finding a suitable signature location for the respective signing party using the grid, a signature location can be determined by adjusting the grid from the first number of cells to a second number of cells each having a second cell size and identifying the respective signing party and a corresponding signature location using the grid as adjusted. In some embodiments, a suitable signature location can be identified by using the grid to identify white space in the image and searching for a white space near a signing party.

One embodiment comprises a system comprising a processor and a non-transitory computer-readable storage medium that stores computer instructions translatable by the processor to perform a method substantially as described herein. Another embodiment comprises a computer program product having a non-transitory computer-readable storage medium that stores computer instructions translatable by a processor to perform a method substantially as described herein. Numerous other embodiments are also possible.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions, and/or rearrangements may be made within the scope of the disclosure without departing from the spirit thereof, and the disclosure includes all such substitutions, modifications, additions, and/or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1 depicts a diagrammatical representation of a networked computing environment where embodiments disclosed herein can be implemented.

FIG. 2 shows an example of a document with potential signing parties.

FIG. 3 depicts a diagrammatical representation of a grid overlaying an image of the document shown in FIG. 2, according to some embodiments disclosed herein.

FIG. 4 depicts a diagrammatical representation of outputs from an OCR facility, including recognized characters and corresponding bounding boxes, according to some embodiments disclosed herein.

FIGS. 5-9 show examples of how potential signature locations for placing signature placeholders can be determined using outputs from the OCR facility and/or a grid overlaying a document image according to some embodiments disclosed herein.

FIG. 10 depicts a diagrammatical representation of a user interface displaying dynamically programmatically generated signature placeholders respectively positioned adjacent to corresponding signing parties according to some embodiments disclosed herein.

FIG. 11 depicts a diagrammatical representation of a prior art user interface showing how a user can manually insert a signature placeholder.

FIG. 12 is a flow chart that illustrates an example of a method for dynamic signature placeholder generation according to some embodiments disclosed herein.

FIG. 13 illustrates an exemplary architecture for a network computing environment for implementing an embodiment disclosed herein.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions, and/or rearrangements within the spirit and/or scope of the underlying inventive concept will become apparent to those skilled in the art from this disclosure.

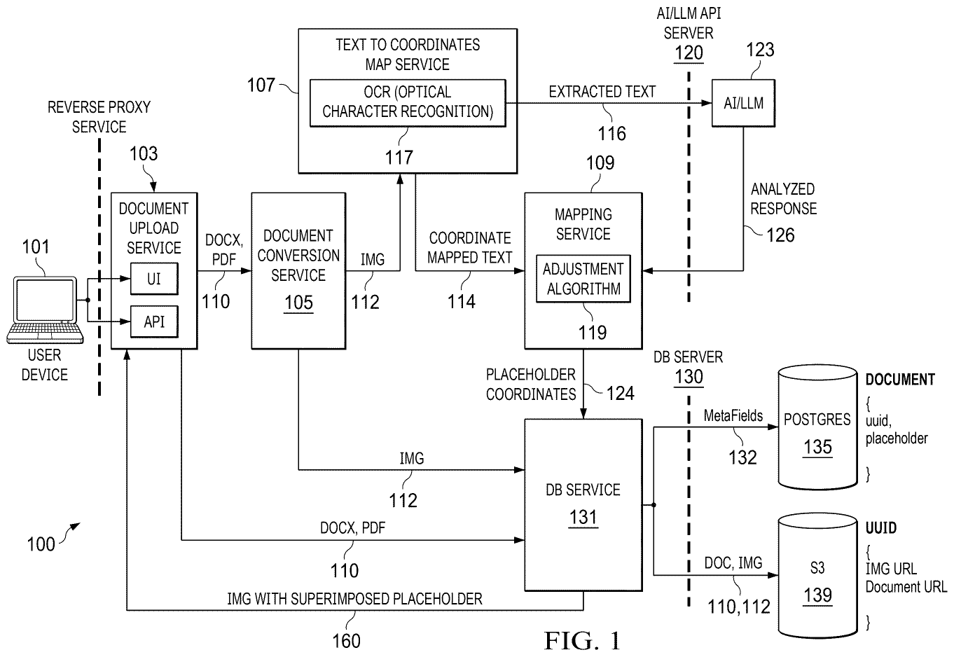

FIG. 1 depicts a diagrammatical representation of a networked computing environment where embodiments of a system 100 disclosed herein can be implemented. In some embodiments, the system 100 may receive, through a document upload service 103, a document 110 from a user device 101. Utilizing a document conversion service 105, the system 100 may generate an image 112 of the document 110 and processes, utilizing a text-to-coordinates mapping service 107, the image 112 of the document 110.

In some embodiments, this processing may entail providing the image 112 of the document 110 as input to an optical character recognition (OCR) facility 117. The OCR facility 117, in turn, is operable to recognize characters in the image 112 and output a text string 116 containing the recognized characters from the image and bounding box coordinates for the recognized characters. The text string 116 is communicated to a large language model (LLM) service 123 provided by an AI/LLM server 120. The LLM service 123 takes the text string 116 as input and returns a response 126 containing words of interest identified from the text string 116. In some embodiments, utilizing a mapping service 109 and based on the words of interest in the document (i.e., the output 126 from the LLM service 123), the system 100 can determine signature placeholders and signature placeholder coordinates in the document for the signature placeholders. The mapping service 109 is operable to run an adjustment algorithm or logic 119, discussed below, on the recognized characters and the bounding box coordinates for the recognized characters (i.e., the coordinate mapped text 114) received from the text-to-coordinates mapping service 107 and output placeholder coordinates 124 to a database service 131.

In some embodiments, the database service 131 can store the signature placeholders and their corresponding signature placeholder coordinates in a database 135 managed by a database server 130. In some embodiments, the database 135 can be a metadata database with metadata fields. The metadata database can be configured for storing the signature placeholders and their corresponding signature placeholder coordinates in corresponding metadata fields as metadata 132. In some embodiments, the document 110 and the image 112 can also be stored in a data storage such as a data store 139.

In some embodiments, the signature placeholders with the signature placeholder coordinates are returned to the document upload service 103 which, in turn, positions the signature placeholders at the signature placeholder coordinates over the document displayed on the user device. In some embodiments, the database service 131 can be configured for superimposing the signature placeholders at the signature placeholder coordinates over the image 112 and return the image 112 with the superimposed signature placeholders 160 to the document upload service 103 for display on a user interface on the user device 101.

In some embodiments, the signature placeholders can be determined by identifying signing parties from the words of interest and, for each respective signing party, determining a signature location near the respective signing party for placing a corresponding signature placeholder. In some embodiments, each respective signing party can be identified from the words of interest by determining a first name and a second name of the respective signing party and concatenating the first name and the second name to identify the respective signing party.

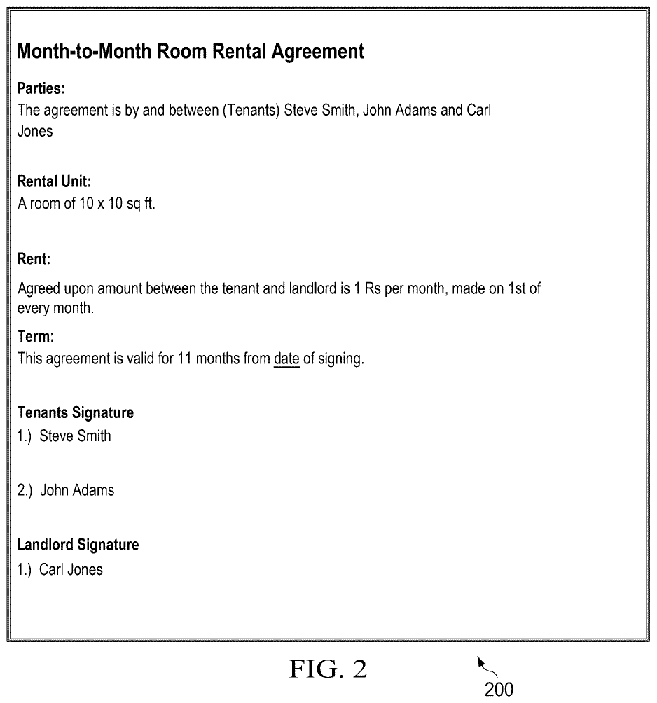

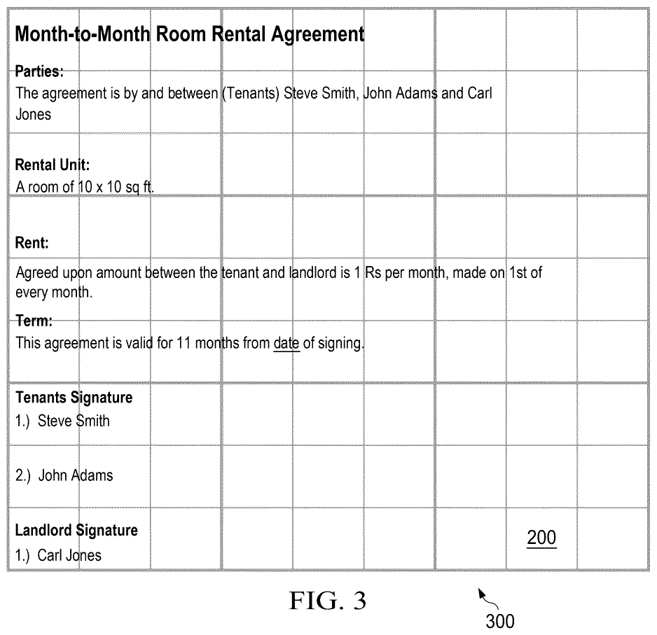

In some embodiments, a suitable signature location can be determined by positioning a grid overlaying the image of the document and identifying the respective signing party and the signature location using the grid. FIG. 2 shows a non-limiting example of an image 200 of a document with potential signing parties. FIG. 3 depicts a diagrammatical representation of a grid 300 overlaying the document image 200, according to some embodiments disclosed herein.

In some embodiments, the grid can consist of a first number of cells each having a first cell size. Responsive to not finding a suitable signature location for the respective signing party using the grid, a signature location can be determined by adjusting the grid from the first number of cells to a second number of cells each having a second cell size and identifying the respective signing party and a corresponding signature location using the grid as adjusted. In some embodiments, a suitable signature location can be identified by using the grid to identify white space in the image and searching for a white space near a signing party.

This grid structure provides coordinates for searching suitable locations in a document for signature placeholders. In some embodiments, the grid structure itself can be scaled or otherwise adjusted according to the layout of the underlying document (e.g., font size, content structure, etc.). For documents with complex layouts (e.g., tables, forms, etc.), a computer vision, machine learning, or image processing library (e.g., OpenCV) can be utilized to detect specific form fields or signature lines based on their visual properties (e.g., straight lines, boxes, etc.).

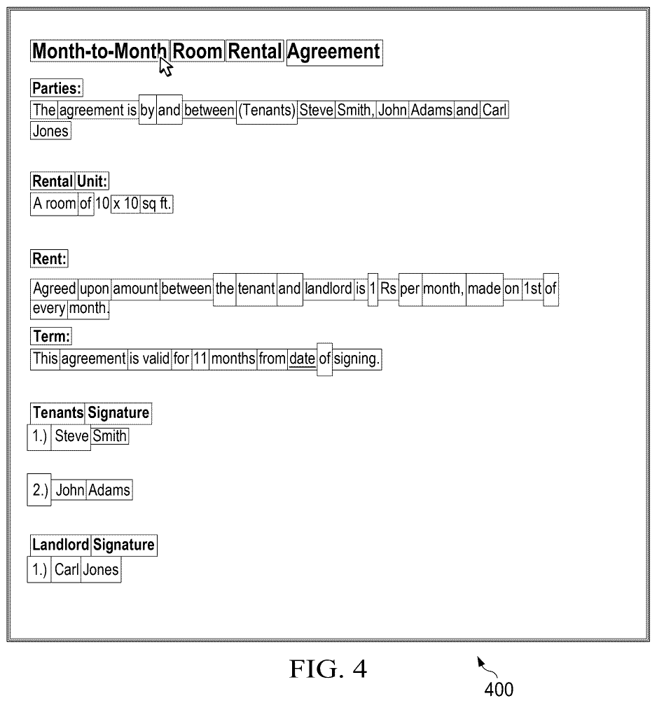

In the example of FIG. 2, the document is a contract and lists parties involved in the contract, such as their names and respective roles (e.g., a landlord and two tenants). The text string 116 from the OCR facility 117 could contain these names and their roles. FIG. 4 depicts a diagrammatical representation of outputs 400 from the OCR facility 117, including recognized characters and corresponding bounding boxes, according to some embodiments disclosed herein.

The LLM service 123, in turn, would identity the names and their roles as identified entities in the analyzed response 126. As discussed above with reference to FIG. 1, the text-to-coordinates mapping service 107 would provide the coordinate-mapped text 114 to the mapping service 109 which, in turn, provides the identified entities from the LLM service 123 and the coordinate-mapped text 114 from the text-to-coordinates mapping service 107 as input to the adjustment logic 119.

In some embodiments, the adjustment logic 119 is operable to identify a category for each entity name (e.g., determining whether an identified entity is a person, an organization, etc.) provided by the LLM service 123. If the category thus identified indicates that the entity is a person, then the adjustment logic 119 is operable to combine the coordinate map or FirstName, Middle name, and Last Name as a single entity.

Returning to FIG. 2, the entity names (e.g., “Steve”, “Smith”, “John”, “Adams”, “Carl”, “Jones”) are identified as First Name and Last Name. The adjustment logic 119 notes the coordinate space between the entities names and the categorization of each entity name. Based on the corresponding location for each entity name, the corresponding bounding box coordinates, and the corresponding categorization, the adjustment logic 119 concatenates, joining, or otherwise merge, if possible, each pair of First Name and Last Name in a single bounding box and outputs placeholder coordinates 124 for the bounding box of each concatenated entity name.

Notice that, in the example of FIG. 2, while the bounding boxes for each pair of identified entities (First Name “Steve” and Last Name “Smith” and First Name “John” and Last Name “Adams”) can be joined, the bounding box for the identified entity “Carl” cannot be joined with the bounding box for the identified entity “Jones” because these identities are not adjacent to one another. A way to remediate this situation is discussed below.

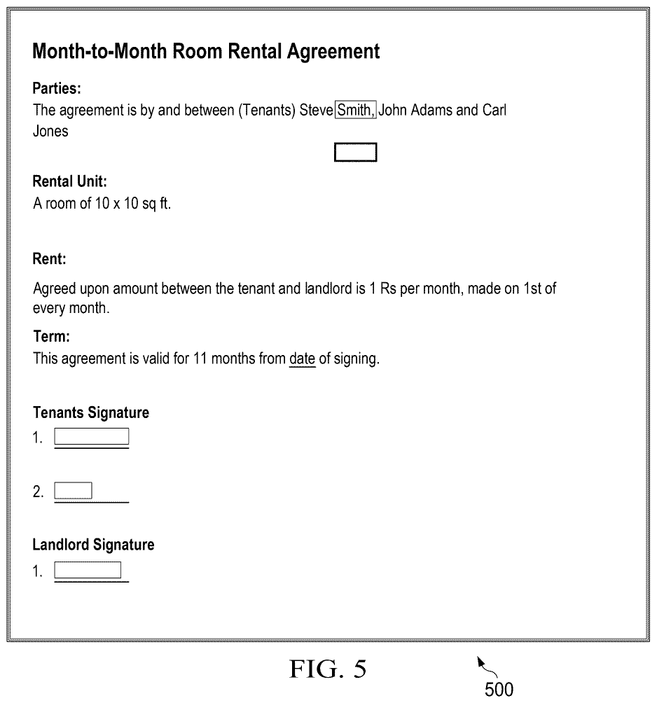

FIG. 5 shows an example of a document 500 with dedicated signing spaces for the signing parties. Each dedicated signing space is associated with a string of “. . . ” or “______”. In such cases, the placeholders are preferably positioned, in order, over or adjacent to corresponding dedicated signing spaces. In this way, there is a direct correlation between the number of dedicated signature spaces and the number of identified unique entities, preferring Person over Organization and Date, as shown in FIG. 5.

If the same entity has multiple occurrences, each occurrence can be weighted. In some embodiments, the adjustment logic 119 can assign a weighted preference based on one or more factors. For instance, preference can be given to proximity to other keywords such as Signature, Date, Place keyword as seen usually in legal documents.

In the example of FIG. 4, multiple occurrences of entities are found. Also, a keyword (i.e., “signature”) is identified. The adjustment logic 119 can be configured to give any entity with proximity to this keyword a weighted preference.

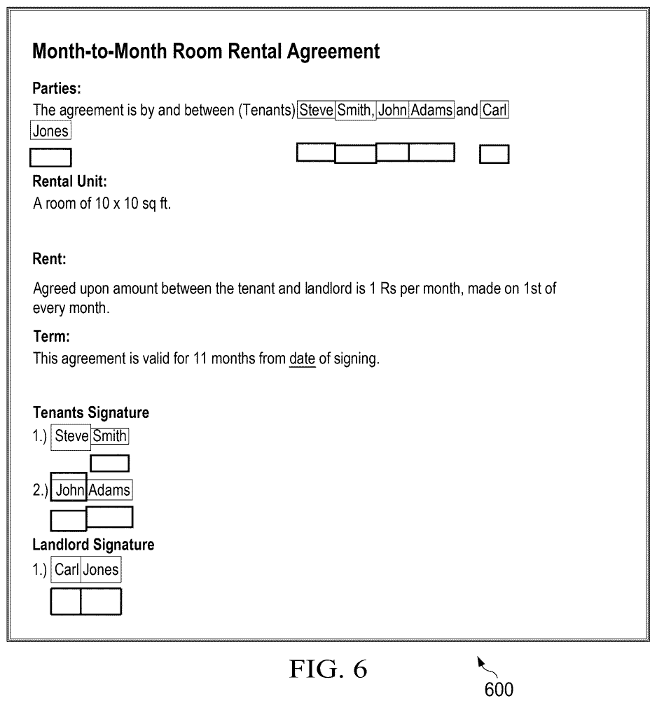

In some embodiments, the adjustment logic 119 can assign a weighted preference to entities with surrounding white spaces near the lower right quadrant of the document, then the lower left quadrant of the document. FIG. 6 shows an example of white spaces near the identified entities and preferences are given to the identified entities with white spaces near the lower left quadrant of a document 600 (since there are no identified entities located at the lower right quadrant of the document 600).

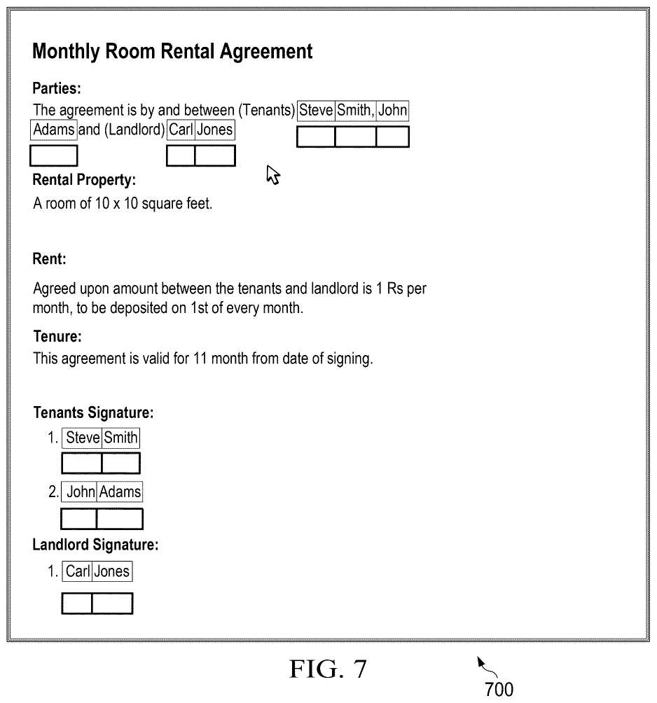

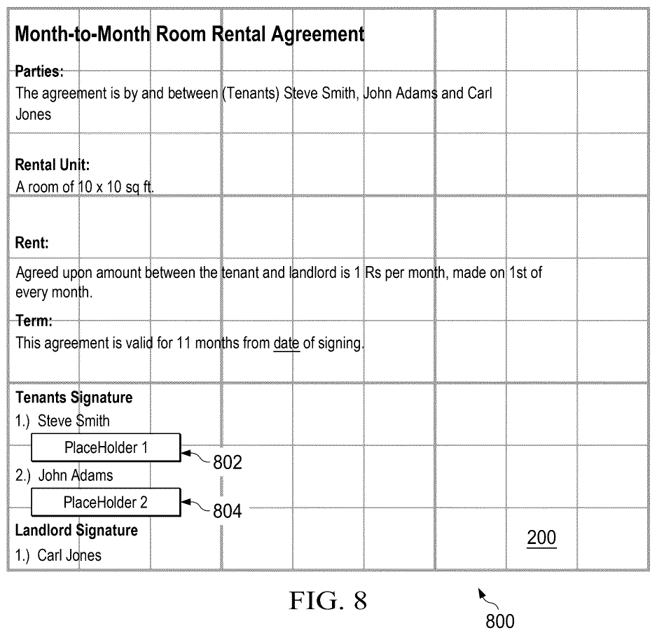

Once a preferred location for a corresponding identified entity is determined, a placeholder is determined based on the available white space(s) near or proximate the identified entity, in a preferred order of directly below the identified entity, the lower right adjacent to the identified entity, then the lower left adjacent to the identified entity, then the right side adjacent to the identified entity. In the example of FIG. 7, the white spaces directly below each respective entity is selected as the corresponding placeholder position for a placeholder. FIG. 8 depicts an example of signature placeholders 802, 803 respectively positioned at the white spaces directly below their respective entities on the document image 200, according to some embodiments disclosed herein.

In some embodiments, there might be multiple occurrences of the same entity. The selection of appropriate white space(s) for placing a signature placeholder can be based on quadrant availability. The rest of the white spaces are rejected.

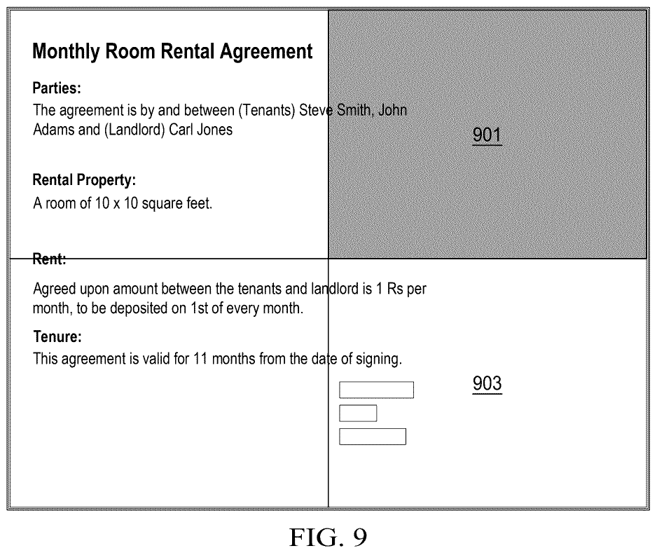

In some cases, if no categorization can be determined for an identified entity, the adjustment logic 119 is operable to identify, by default, a quadrant of the document with the maximum white space and place a placeholder in a column, preferring lower right and then lower left to the identified entity. In the example of FIG. 9, even though the maximum white space is the greyed out quadrant 901, i.e., the upper right quadrant of the document, preference is given to the lower right quadrant 903 of the document for placing the signature placeholders.

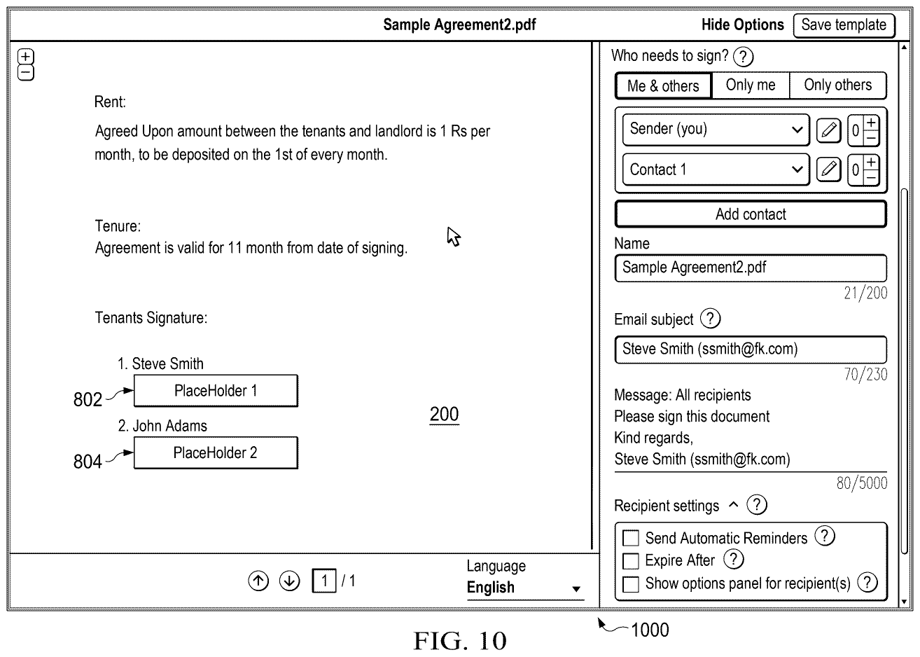

FIG. 10 depicts a diagrammatical representation of a user interface 1000 displaying the dynamically programmatically generated signature placeholders 802, 803 respectively positioned adjacent to corresponding signing parties on the document image 200, according to some embodiments disclosed herein.

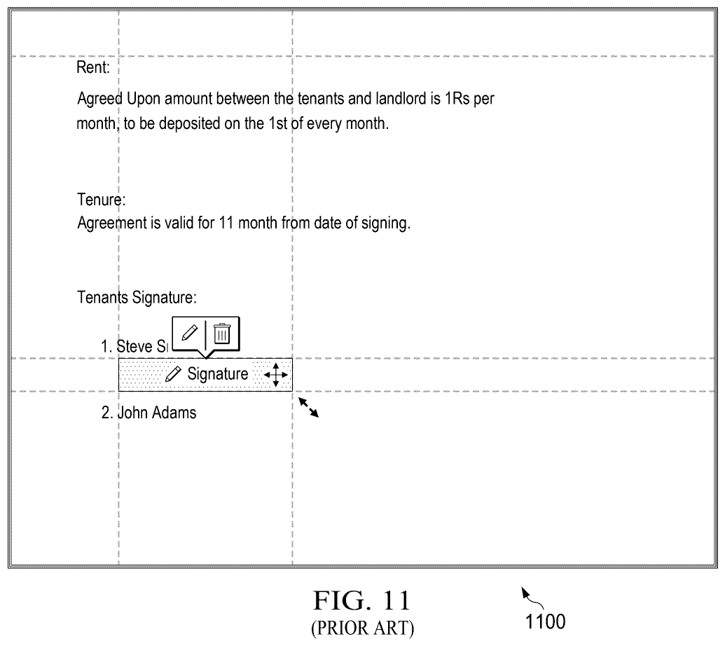

Contrastingly, FIG. 11 depicts a diagrammatical representation of a prior art user interface 1100 showing how a user can manually insert a signature placeholder by dragging and dropping a “Signature” field to a desired location. If there are multiple signing parties, the user would need to identify an appropriate location for each signing party to sign their name and repeat the manual insertion for each signing party. If dating their signature is required, the user would need to again identify an appropriate location for placing a “date” filed for each signing party to date their signature and repeat this manual insertion for each signing party.

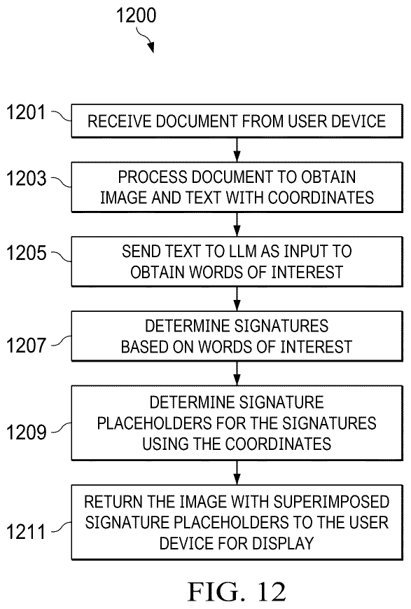

FIG. 12 is a flow chart that illustrates an example of a method 1200 for dynamic signature placeholder generation according to some embodiments disclosed herein. As described above, the method 1200 may comprise receiving a document from a user device (1201), processing the document to obtain an image and text with coordinates (1203). In some embodiments, this processing can leverage an OCR facility, as discussed above. The text thus recognized can be provided as input to an LLM so as to obtain words of interest (e.g., identified entities having a certain categorization) (1205). Based on these words of interest, the number of signatures can be determined (1207). For each signature thus determined, a corresponding signature placeholder can be programmatically determined using the coordinates from the OCR facility (1209). The signatures and their corresponding signature placeholders can be superimposed on the image of the document and returned to the user device for display (1211).

Those skilled in the art will appreciate that the invention described above can be used to intelligently generate placeholders for other types of data fields. For instance, in addition to generating a “signature” placeholder, a “date” placeholder can be similarly generated near or adjacent the “signature” placeholder so that a signer can date their signature. Other types of placeholders may also be generated by augmenting the words of interest based on a document type. For example, if a document is classified as an invoice, then the words of interest for this document type may include terms such as “approved,” “rejected,” “paid,” etc. Other implementations may also be possible.

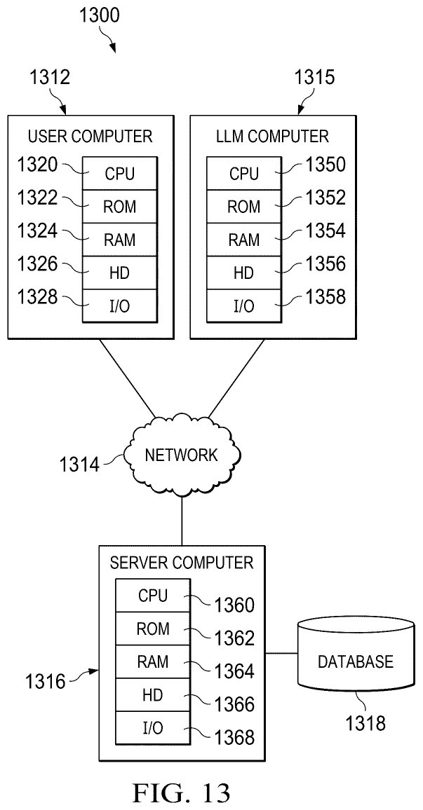

FIG. 13 illustrates an exemplary architecture for network computing environment 1300 that includes network 1314 and computers 1312, 1315, and 1316. Computers 1312, 1315, and 1316 can be bi-directionally coupled to network 1314. Computers 1312, 1315, and 1316 may operate in different computing environments. Computers 1312, 1315, and 1316 may represent example computing systems for a user computer, an LLM server, a document management server, a database server, etc. The system can be bi-directionally coupled to a database 1318 for storing the identified entities, the mapped coordinates, the signatures, the signature placeholders, and so on. Network 1314 may represent a combination of wired and wireless networks that network computing environment 1300 may utilize for various types of network communications known to those skilled in the art.

For the purpose of illustration, a single system is shown for each of computers 1312, 1315, and 1316. However, within each computer, a plurality of computers (not shown) may be interconnected to each other over network 1314. For example, a plurality of user computers may be coupled to network 1314. Each computer may include a data processing system for communicating with an electronic information exchange platform. In some embodiments, computer 1316 may implement a system disclosed herein operating in a networked computing environment.

Computer 1312 can include central processing unit (“CPU”) 1320, read-only memory (“ROM”) 1322, random access memory (“RAM”) 1324, hard drive (“HD”) or storage memory 1326, and input/output device(s) (“I/O”) 1328. I/O 1329 can include a keyboard, monitor, printer, electronic pointing device (e.g., mouse, trackball, stylus, etc.), or the like. Computer 1312 can include a desktop computer, a laptop computer, a personal digital assistant, a cellular phone, or nearly any device capable of communicating over a network. Computer 1315 may be similar to computer 1312 and can comprise CPU 1350, ROM 1352, RAM 1354, HD 1356, and I/O 1358.

Likewise, computer 1316 may include CPU 1360, ROM 1362, RAM 1364, HD 1366, and I/O 1368. Computer 1316 may include one or more backend systems configured for providing a variety of services to computers 1312 and 1315 over network 1314. Many other alternative configurations are possible and known to skilled artisans.

Each of the computers shown in FIG. 13 may have more than one CPU, ROM, RAM, HD, I/O, or other hardware components. For the sake of brevity, each computer is illustrated as having one of each of the hardware components, even if more than one is used. Each of computers 1312, 1315, and 1316 is an example of a data processing system. ROM 1322, 1352, and 1362; RAM 1324, 1354, and 1364; HD 1326, 1356, and 1366; and database 1318 can include media that can be read by CPU 1320, 1350, or 1360. Therefore, these types of memories include non-transitory computer-readable storage media. These memories may be internal or external to computers 1312, 1315, or 1316.

Portions of the methods described herein may be implemented in suitable software code that may reside within ROM 1322, 1352, or 1362; RAM 1324, 1354, or 1364; or HD 1326, 1356, or 1366. In addition to those types of memories, the instructions in an embodiment disclosed herein may be contained on a data storage device with a different computer-readable storage medium, such as a hard disk. Alternatively, the instructions may be stored as software code elements on a data storage array, magnetic tape, floppy diskette, optical storage device, or other appropriate data processing system readable medium or storage device.

Those skilled in the relevant art will appreciate that the invention can be implemented or practiced with other computer system configurations, including without limitation multi-processor systems, network devices, mini-computers, mainframe computers, data processors, and the like. The invention can be embodied in a special purpose computer or data processor that is specifically programmed, configured, or constructed to perform the functions described in detail herein. The invention can also be employed in distributed computing environments, where tasks or modules are performed by remote processing devices, which are linked through a communications network such as a local area network (LAN), wide area network (WAN), and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks). Example chips may include Electrically Erasable Programmable Read-Only Memory (EEPROM) chips. Embodiments discussed herein can be implemented in suitable instructions that may reside on a non-transitory computer readable medium, hardware circuitry or the like, or any combination and that may be translatable by one or more server machines. Examples of a non-transitory computer readable medium are provided below in this disclosure.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, and other appropriate computer memories and data storage devices. Thus, a computer-readable medium may refer to a data cartridge, a data backup magnetic tape, a floppy diskette, a flash memory drive, an optical data storage drive, a CD-ROM, ROM, RAM, HD, or the like.

The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used to implement the routines, methods or programs of embodiments of the invention described herein, including C, C++, Java, JavaScript, HTML, or any other programming or scripting code, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed, or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any, hardware system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description herein, the meaning of “in” includes “in” and “on” unless the context clearly dictates otherwise.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted. The scope of the disclosure should be determined by the following claims and their legal equivalents.

What is claimed is:

1. A dynamic signature placeholder generation method, comprising:
receiving, by a server computer through a document upload service, a document from a user device;
generating, by the server computer utilizing a document conversion service, an image of the document;
processing, by the server computer utilizing a text-to-coordinates mapping service, the image of the document, wherein the processing comprises providing the image as input to an optical character recognition (OCR) facility and wherein the OCR facility is operable to recognize characters in the image and output a text string containing the recognized characters from the image and bounding box coordinates for the recognized characters;
communicating, by the server computer, the text string to a large language model (LLM) service provider computer, wherein the LLM service provider computer takes the text string as input to a LLM and returns a response containing words of interest identified from the text string;
determining, by the server computer utilizing a mapping service and the bounding box coordinates for the recognized characters:
signature placeholders based on the words of interest in the document; and
signature placeholder coordinates in the document for the signature placeholders;
returning, by the server computer, the signature placeholders with the signature placeholder coordinates to the document upload service, wherein the document upload service positions the signature placeholders at the signature placeholder coordinates over the document displayed on the user device.

2. The dynamic signature placeholder generation method according to claim 1, wherein the determining the signature placeholders comprises:
identifying signing parties from the words of interest; and
for each respective signing party, determining a signature location near the respective signing party for placing a corresponding signature placeholder.

3. The dynamic signature placeholder generation method according to claim 2, wherein the identifying signing parties from the words of interest comprises:
determining a first name and a second name of the respective signing party; and
concatenating the first name and the second name to identify the respective signing party.

4. The dynamic signature placeholder generation method according to claim 2, wherein the determining the signature location comprises:
positioning a grid overlaying the image of the document; and
identifying the respective signing party and the signature location using the grid.

5. The dynamic signature placeholder generation method according to claim 4, wherein the grid consists of a first number of cells each having a first cell size and wherein, responsive to not finding the signature location for the respective signing party using the grid, the determining the signature location further comprises:
adjusting the grid from the first number of cells to a second number of cells each having a second cell size; and
identifying the respective signing party and the signature location using the grid as adjusted.

6. The dynamic signature placeholder generation method according to claim 4, wherein the identifying the signature location comprises:
using the grid to identify white space in the image; and
searching for a white space near the respective signing party.

7. The dynamic signature placeholder generation method according to claim 1, further comprising:
storing the signature placeholders with the signature placeholder coordinates in the document in a metadata database.

8. A system, comprising:
a processor;
a non-transitory computer-readable medium; and
instructions stored on the non-transitory computer-readable medium and translatable by the processor for:
receiving, through a document upload service, a document from a user device;
generating, utilizing a document conversion service, an image of the document;
processing, utilizing a text-to-coordinates mapping service, the image of the document, wherein the processing comprises providing the image as input to an optical character recognition (OCR) facility and wherein the OCR facility is operable to recognize characters in the image and output a text string containing the recognized characters from the image and bounding box coordinates for the recognized characters;
communicating the text string to a large language model (LLM) service provider computer, wherein the LLM service provider computer takes the text string as input to a LLM and returns a response containing words of interest identified from the text string;
determining, utilizing a mapping service and the bounding box coordinates for the recognized characters:
signature placeholders based on the words of interest in the document; and
signature placeholder coordinates in the document for the signature placeholders;
returning the signature placeholders with the signature placeholder coordinates to the document upload service, wherein the document upload service positions the signature placeholders at the signature placeholder coordinates over the document displayed on the user device.

9. The system of claim 8, wherein the determining the signature placeholders comprises:
identifying signing parties from the words of interest; and
for each respective signing party, determining a signature location near the respective signing party for placing a corresponding signature placeholder.

10. The system of claim 9, wherein the identifying signing parties from the words of interest comprises:
determining a first name and a second name of the respective signing party; and
concatenating the first name and the second name to identify the respective signing party.

11. The system of claim 9, wherein the determining the signature location comprises:
positioning a grid overlaying the image of the document; and
identifying the respective signing party and the signature location using the grid.

12. The system of claim 11, wherein the grid consists of a first number of cells each having a first cell size and wherein, responsive to not finding the signature location for the respective signing party using the grid, the determining the signature location further comprises:
adjusting the grid from the first number of cells to a second number of cells each having a second cell size; and
identifying the respective signing party and the signature location using the grid as adjusted.

13. The system of claim 11, wherein the identifying the signature location comprises:
using the grid to identify white space in the image; and
searching for a white space near the respective signing party.

14. The system of claim 8, wherein the instructions are further translatable by the processor for:
storing the signature placeholders with the signature placeholder coordinates in the document in a metadata database.

15. A computer program product comprising a non-transitory computer-readable medium storing instructions translatable by a processor for:
receiving, through a document upload service, a document from a user device;
generating, utilizing a document conversion service, an image of the document;
processing, utilizing a text-to-coordinates mapping service, the image of the document, wherein the processing comprises providing the image as input to an optical character recognition (OCR) facility and wherein the OCR facility is operable to recognize characters in the image and output a text string containing the recognized characters from the image and bounding box coordinates for the recognized characters;
communicating the text string to a large language model (LLM) service provider computer, wherein the LLM service provider computer takes the text string as input to a LLM and returns a response containing words of interest identified from the text string;
determining, utilizing a mapping service and the bounding box coordinates for the recognized characters:
signature placeholders based on the words of interest in the document; and
signature placeholder coordinates in the document for the signature placeholders;
returning the signature placeholders with the signature placeholder coordinates to the document upload service, wherein the document upload service positions the signature placeholders at the signature placeholder coordinates over the document displayed on the user device.

16. The computer program product of claim 15, wherein the determining the signature placeholders comprises:
identifying signing parties from the words of interest; and
for each respective signing party, determining a signature location near the respective signing party for placing a corresponding signature placeholder.

17. The computer program product of claim 16, wherein the identifying signing parties from the words of interest comprises:
determining a first name and a second name of the respective signing party; and
concatenating the first name and the second name to identify the respective signing party.

18. The computer program product of claim 16, wherein the determining the signature location comprises:
positioning a grid overlaying the image of the document; and
identifying the respective signing party and the signature location using the grid.

19. The computer program product of claim 18, wherein the grid consists of a first number of cells each having a first cell size and wherein, responsive to not finding the signature location for the respective signing party using the grid, the determining the signature location further comprises:
adjusting the grid from the first number of cells to a second number of cells each having a second cell size; and
identifying the respective signing party and the signature location using the grid as adjusted.

20. The computer program product of claim 18, wherein the identifying the signature location comprises:
using the grid to identify white space in the image; and
searching for a white space near the respective signing party.
